(19) United States
(12) Patent Application Publication
(10) Pub. No.: US 2016/0204401 A1
(43) Pub. Date: Jul. 14, 2016

(54) RECONFIGURABLE VEHICULAR BATTERY ENCLOSURE COMPONENTS

(71) Applicant: GM GLOBAL TECHNOLOGY OPERATIONS LLC, Detroit, MI (US)

(72) Inventors: Randy C. Curtis, Macomb, MI (US); Duane D'Artagnan Kruger, Washington, MI (US); Randall S. Champagne, Riverview, MI (US)

(21) Appl. No.: 14/596,278

(22) Filed: Jan. 14, 2015

(51) Int. Cl. H01M 2/10

(52) U.S. Cl. CPC H01M 2/1077; H01M 2220/20

(57) ABSTRACT

A modular battery pack and method of making a battery pack. Prismatic battery cells are aligned within the enclosure such that reconfigurable adjusting of the enclosure and its components may take place without having to redesign either. In this way, battery packs containing a different number of successively smaller battery modules or battery cells may be placed within the common enclosure. Slidably mountable features of at least some of the components within the enclosure help promote this modularity. The enclosure includes a tray that defines a substantially constant section along a mounting surface that corresponds to a stacking axis of the aligned prismatic cells or modules. Numerous brackets that can help secure the batteries, their electrical leads or components are disposed along a portion of the mounting surface such that the cooperation between the brackets and the mounting surface of the tray is invariant, regardless of where along the elongate dimension the cooperation occurs.

### BACKGROUND OF THE INVENTION

This invention relates generally to the containment of individual battery cells that make up a vehicular battery pack, and more particularly to the use of reconfigurable components that make up a battery enclosure that is adaptable to multiple vehicular battery pack variants.

Lithium-ion and related batteries are being used in automotive and related transportation applications as a way to supplement, in the case of hybrid electric vehicles (HEVs), or supplant, in the case of purely electric vehicles (EVs), conventional internal combustion engines (ICEs). The ability to passively store energy from stationary and portable sources, as well as from recaptured kinetic energy provided by the vehicle and its components, makes such batteries ideal to serve as part of a propulsion system for cars, trucks, buses, motorcycles and related vehicular platforms. In one form suitable for automotive applications, individual battery cells are combined into larger assemblies such that the current or voltage is increased to generate the desired power output. In the present context, larger module and pack assemblies are made up of one or more cells joined in series, parallel or both, and include additional structure to ensure proper installation into the vehicle. Although the term “battery pack” is used herein to discuss a substantially complete battery assembly for use in propulsive power applications, it will be understood by those skilled in the art that related terms—such as “battery unit” or the like—may also be used to describe such an assembly, and that either term may be used interchangeably without a loss in such understanding.

In one form, the individual cells that make up a battery pack are configured as rectangular (i.e., prismatic) cans that define a rigid outer housing known as a cell case. In another form, the individual cells are housed in a thinner, flexible rectangular pouch. Both variants can be placed in a facing arrangement (much like a deck of cards) along a stacking axis formed by the aligned parallel plate-like surfaces. Positive and negative terminals situated on one edge on the exterior of the housing are laterally-spaced from one another relative to the stacking axis and act as electrical contacts for connection (via busbar, for example) to an outside load or circuit. With particular regard to the prismatic can, numerous individual alternating positive and negative electrodes are spaced apart from one another within the can along the stacking direction and kept electrically isolated by non-conductive separators. Leads from each of the negative electrodes are gathered together inside the housing to feed the externally-projecting negative terminal, while leads from each of the positive electrodes are likewise gathered together to feed the externally-projecting positive terminal.

Regardless of which variant is employed, the enclosure used to contain the stacked individual cells needs to provide secure attachment to and containment within the corresponding vehicle compartment. Traditionally, this has necessitated the use of enclosure assemblies that are complex, expensive and not adaptable to modifications in battery pack configurations, such as battery packs of varying sizes. As such, significant design and engineering time is needed to develop a new enclosure whenever the circumstances call for changes to the size or shape of the pack.

### SUMMARY OF THE INVENTION

In accordance with the teachings of the present invention, a design for securing one or more battery cells into a larger battery assembly (such as a battery module or a battery pack) is disclosed. In the present context, the design is predominantly configured for prismatic can battery cells, although it could be applied to prismatic pouch variants as well. Likewise, an assembly of components for a battery pack used for vehicular applications may include—in addition to numerous battery cells—cooling, securing, electrical connectivity, control and monitoring, as well other equipment that, while not contributing to the production of electric power, form an important part of the overall battery system packaging and assembly. Also within the present context, the terms “modular”, “reconfigurable” and their variants are meant to cover the components such that the resulting assembly may be tailored to a specific size of the aligned battery cells (particularly lengthwise along the stacking axis formed by the cells) such that by enclosing such battery cells, new or redesigned enclosure components are not needed; this in turn promotes a form of “off-the-shelf” adaptability of the enclosure and its constituent components.

According to an aspect of the present invention, an automotive battery pack assembly is disclosed. The assembly includes multiple modular components including a tray defining a mounting surface thereon to accept a plurality of prismatic batteries, the mounting surface is configured to have a substantially constant section along the elongate dimension; this promotes reconfigurable placement of the other components that make up the enclosure, as well as the battery cells and electrical equipment that makes up the battery pack. This promotes the desired modular, reconfigurable enclosure. The components that are attachable to the tray or one another include upstanding walls disposed about a substantial periphery of the tray and brackets disposed along a portion of the tray mounting surface such that the brackets substantially fit within a volume defined by the walls and the tray. In particular, at least one of the brackets is in cooperation with the tray such that attachment between them is invariant regardless of where along the elongate dimension the cooperation occurs. Additional enclosure components, such as a top cover, may be disposed over the volume.

According to another aspect of the present invention, an automotive battery pack assembly includes a plurality of prismatic batteries aligned along a stacking axis and numerous modular components made up of a tray that defines a mounting surface to accept the batteries along its elongate dimension and widthwise dimension. The mounting surface defines a substantially constant cross section along its elongate dimension to promote the invariant cooperation between it and numerous brackets that are disposable along it; this in turn facilitates reconfigurable placement of the battery cells and accompanying electrical equipment within the enclosure to accommodate variations in cells size, number or orientation. Other components may include upstanding walls, a top cover and other features to help provide containment and at least partial isolation of the batteries and related equipment contained therein.

According to yet another aspect of the invention, a method of assembling an automotive battery pack is disclosed. The method includes placing numerous prismatic batteries on a support surface such that the batteries are aligned along one or more stacking axes, and placing a plurality of components cooperative with the support surface such that upon at least one of direct or indirect attachment therebetween, a modular enclosure is defined about a substantial entirety of the batteries. At least one of the components is a bracket that may be disposed along a portion of the mounting surface such that the bracket is in cooperation with the tray such that attachment therebetween is invariant regardless of where along the elongate dimension the cooperation occurs. Significantly, the mounting surface defines a substantially constant section along the elongate dimension to facilitate ease of placement of the batteries and the corresponding enclosure components along a substantial continuum of the support surface. In one form, the numerous batteries are grouped into larger (generally box-shaped) battery modules such that one or more of such modules may be housed within the enclosure, and that the enclosure is scalable to accommodate the respective number of modules. Because efficient placement of such battery modules is important, the stacking axis may be made to substantially coincide with the support surface's elongate dimension for one module, while another module can be arranged such that the stacking axis substantially coincides with the support surface widthwise dimension, as well as combinations therebetween.

### BRIEF DESCRIPTION OF THE DRAWINGS

The following detailed description of the preferred embodiments of the present invention can be best understood when read in conjunction with the following drawings, where like structure is indicated with like reference numerals and in which:

FIG. 1 shows a vehicle with a hybrid propulsion system in the form of a battery pack and an internal combustion engine;

FIG. 2 shows a notional battery cell configured as a prismatic can that can be placed within a battery enclosure according to the present invention;

FIG. 3 shows an exploded view of many of the various individual components used to make a double-row enclosure according to one aspect of the present invention;

FIG. 4 shows the attachment of a support to the underside of a tray that forms the primary structure of the enclosure of FIG. 3;

FIG. 5 shows the attachment of a battery disconnect module bracket onto an upper surface of the tray of FIG. 4;

FIGS. 6A through 6C show the placement of a battery system monitor bracket onto the battery disconnect module bracket and a manual service disconnect bracket onto the tray of FIG. 5 at three notional locations;

FIG. 7 shows the attachment of front and back perforate covers onto an upper surface of the tray of FIG. 3;

FIG. 8 shows the attachment of a top cover to a pair of closeouts;

FIG. 9 shows the attachment of a pair of closeouts onto opposing elongate ends of an upper surface of the tray of FIG. 3;

FIG. 10 shows the attachment of the battery system monitor bracket and manual service disconnect bracket onto a battery electronics module that is mounted onto the battery disconnect module bracket;

FIG. 11 shows the attachment of the front and back perforate covers to the partial assembly of FIG. 10, as well as the inclusion of another battery electronics module;

FIG. 12 shows the attachment of the top cover to the partial assembly of FIG. 11;

FIG. 13 shows a shorter variant of the enclosure of FIG. 12;

FIG. 14 shows a single row variant of the enclosure of FIG. 12; and

FIG. 15 shows an enclosure according to another embodiment of the present invention where some of the battery modules may be stacked along the enclosure elongate axis, while others are stacked along the shorter lateral axis.

### DETAILED DESCRIPTION OF THE PREFERRED EMBODIMENTS

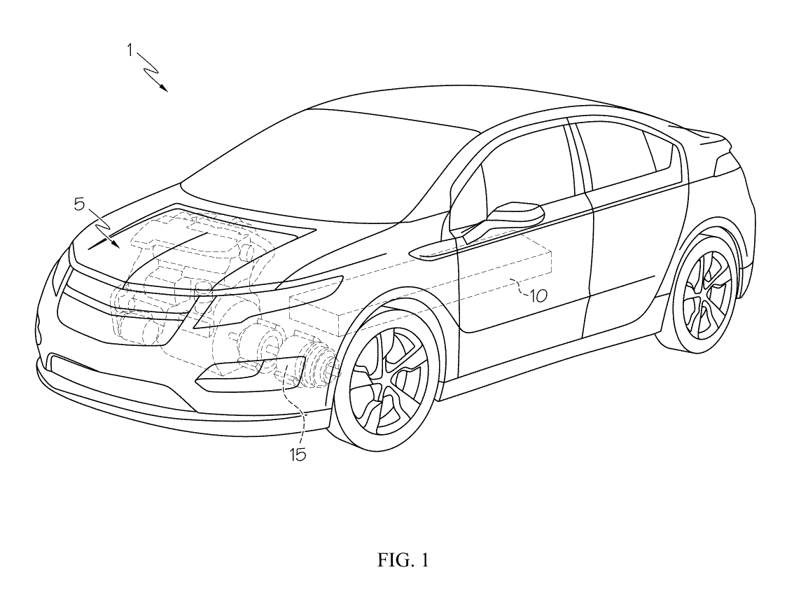

Referring first to FIG. 1, a vehicle 1 includes a hybrid propulsion system in the form of an electric power source made up of a conventional ICE 5 and one or more battery packs placed within a simplified version of the enclosure 10 of the present invention; both the ICE 5 and the battery packs are cooperative with an electric motor 15. Such a vehicle is known as a hybrid electric vehicle (HEV). It will be appreciated by those skilled in the art that vehicle 1 may not require an ICE 5, in such case, rather than being an HEV, it is an electric vehicle (EV); either form is within the scope of the present invention. Additional drivetrain components (none of which are shown) useful in providing propulsive power to one or more of the wheels and coupled to one or both of the battery packs and ICE 5 are understood to include rotating shafts, axles, transmission, controllers or the like. In one preferred form, the motor 15 acts as a load on the battery pack (or packs). Although the enclosure 10 for battery pack is notionally shown as an elongate rectangular box disposed along the lengthwise dimension of the vehicle 1 in an undermount format, it will be appreciated that it may be configured with other aspect ratios, dimensions and orientations to better accommodate its placement in and securing to other places within vehicle 1, depending on the need; all such variants are deemed to be compatible with the present invention. In one alternate form, battery pack 10 may be placed within the vehicle 1 behind the rear passenger seat; either of these (as well as other) placement variants are deemed to be within the scope of the present invention. Furthermore, while vehicle 1 is presently shown as a car, the applicability of the hybrid propulsion system to other such automotive forms (including trucks, buses, aircraft, watercraft, spacecraft and motorcycles) is deemed to be within the scope of the present invention.

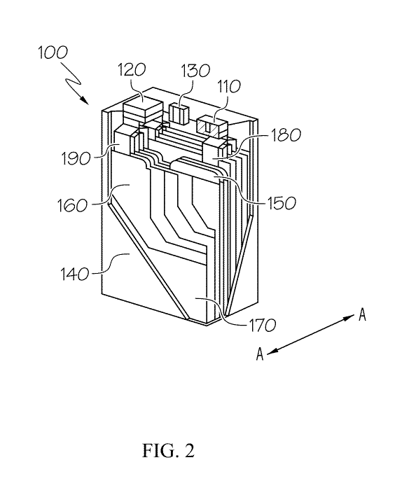

Referring next to FIG. 2, a representative prismatic can lithium-ion battery cell 100 is shown. Unlike pouch-style battery cell variants (not shown), which—although they have in common a generally flat, rectangular stackable shape in a generally similar manner—include numerous cells interspersed with cooling plates and other components, as well as thin peripheral edge and even thinner conductive foil tabs extending from the pouch edge, the prismatic can cell 100 has the anode and cathode packaged within a welded rigid metal (for example, aluminum) rectangular canister, enclosure or similar self-supporting housing. Regardless of whether the cells are in can form (such as cell 100) or pouch form, both may be used in conjunction with the enclosure of the present invention. Shown in a partial cutaway view, the notional construction of cell 100 that is usable with the present invention includes positive and negative terminals 110, 120 projecting out of its top edge, along with a safety vent 130. Within the cell's 100 rigid outer case 140 are numerous positive and negative electrodes 150, 160 and non-conductive interspersed separators 170. Leads (in the form of tabs 180, 190) from each of the electrodes 150, 160 are gathered together inside the cell case 140 to feed the respective terminals 110, 120. Within the present context, numerous battery 100 cells may be combined into a module 200 (shown in FIG. 15), which in turn may be formed into a larger battery pack (also not shown). The generally planar outer surfaces of each cell 100 facilitates the stacking of numerous such cells along a stacking axis A in a manner similar to that of the deck of cards mentioned above.

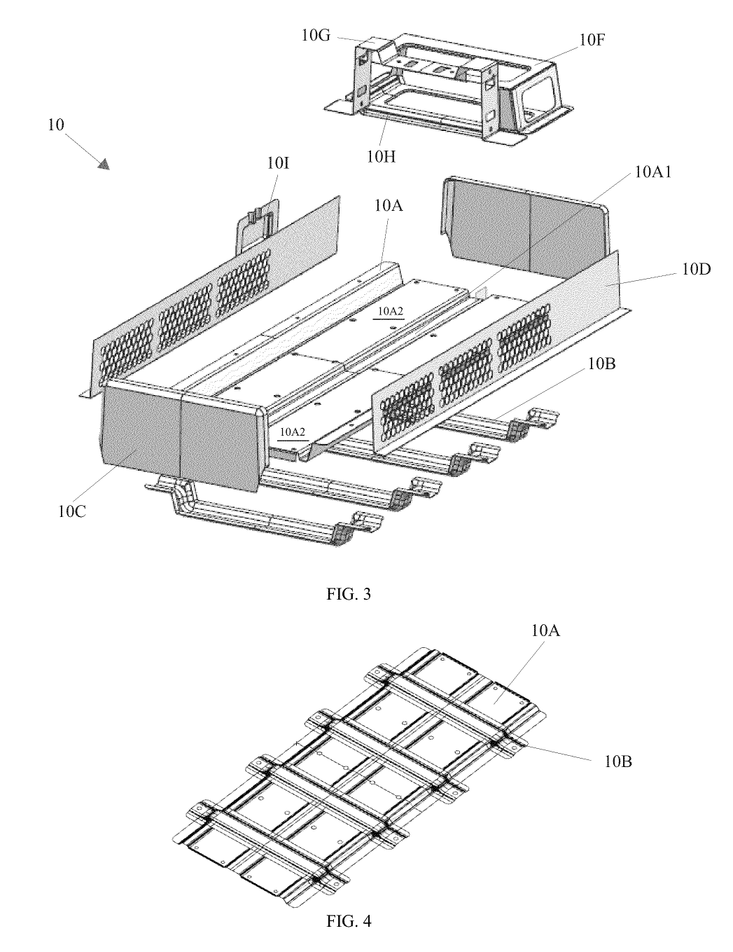

Referring next to FIG. 3, the various components that make up enclosure 10 are shown in their disassembled state. Significantly, many of the components are of modular construction from simple geometric shapes and can be made from relatively inexpensive raw materials to ensure ease of fabrication, assembly and reconfiguration to accommodate larger or smaller numbers of battery cells placed therein. The modular nature of the components promotes scalability, component reuse and reconfiguration. The first of these, tray 10A, forms the strong backbone (i.e., support surface) of enclosure 10 and promotes ease of reconfiguration by virtue of its constant cross-sectional shape along its elongate (i.e., lengthwise) axis. In one form, tray 10A can be produced through inexpensive fabrication techniques, such as roll-forming, low force flanging or the like, and can be made from steel, aluminum or plastic-based materials. A variety of apertures can be added (as shown) during or after such forming operations. Tray 10A features integrally-formed enhanced stiffening by virtue of a center spine 10A1 and a pair of lateral channels (also referred to as beads) 10A2 that run along the elongate dimension of the tray 10A. Although not shown, more stiffening channels can be used if desired, and all such forms are deemed to be within the scope of the present invention. The spine 10A1 and channels 10A2 define a lengthwise dimension that—along with the other surfaces of tray 10A—have a substantially constant cross-sectional area throughout their length to ensure that any other component mounted thereon for subsequent fixation can be situated at any place along a substantial entirety of the length of the upper surface of tray 10A. In any event, the substantially horizontal surface formed within tray 10A is used to mount various configurations of the battery cells 100, modules 200 or the like.

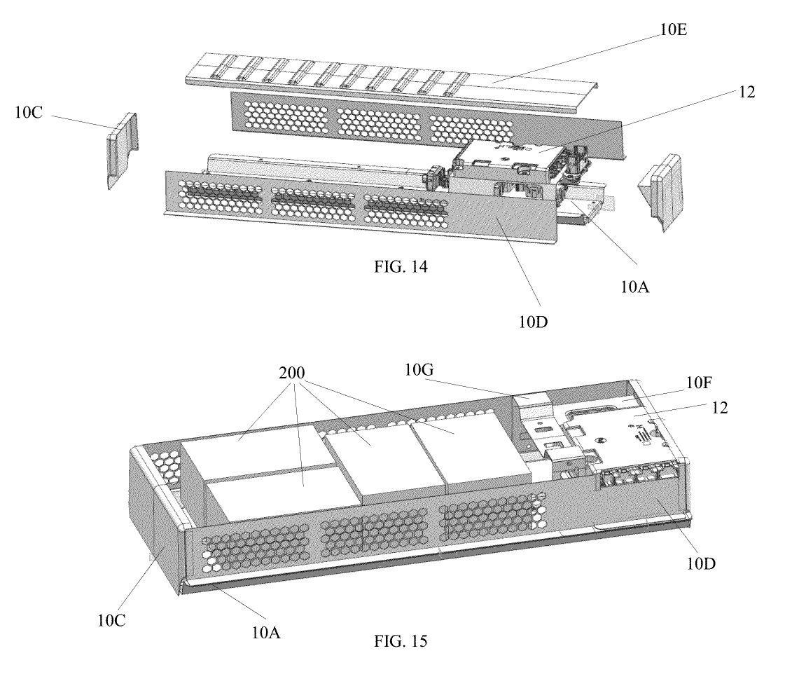

The tray 10A shown is sized to accept two side-by-side rows of four battery modules (where each module, such as module 200 of FIG. 15, contains between 10 to 15 individual prismatic cells) for a total of eight such modules; it will be appreciated by those skilled in the art that the tray 10A can be widthwise sized to accept a single row (such as shown in FIG. 14) of four modules or shortened (such as shown in FIG. 13) and that these and other such varying sizes are within the scope of the present invention. Equally important is that the stacking axis A shown above in conjunction with FIG. 2 need not coincide with the elongate dimension of tray 10A. In fact, the modular nature of the enclosure 10 and the battery cell modules 200 that can be placed therein is that efficient, repeatable packing is preserved, regardless of width or length variations of the enclosure 10, and regardless of the number of battery cells 100 and corresponding modules 200 employed. As such, as shown by the embodiment of FIG. 15, the ability to engage in mix-and-match placement of the various modules 200 such that their stacking axes may extend along either of the tray 10A elongate or lateral (i.e., widthwise) dimensions is promoted by the reconfigurable nature of the various components shown in FIG. 3. This in turn significantly promotes battery pack scalability and a related emphasis on reusable components. As such, anywhere from one to eight battery modules 200 may be placed onto the tray 10A shown. Furthermore, the number of individual cells 100 that make up each module 200 may be tailored to the dimensions within the enclosure 1; by way of example, two-module, four-module, six-module and eight-module variants can be rapidly reconfigured, while the number of individual cells 100 within each module 200 may be the same or different. As such some of the modules 200 may be configured to hold ten cells 100, while others may be configured to hold twelve, while the placement of electronic equipment (discussed in more detail below), supports or the like may be correspondingly tailored. In another variant (not shown) the individual cells 100 may be all aligned such that the stacking axis A depicted in FIG. 2 is commensurate with the single row or double-row enclosure 10 configurations in what is known as a “super-module” configuration; in such construction, there are no separate modules (whether of ten or twelve cell variants) to be oriented and aligned within the enclosure 10, but rather a continuous alignment of as many cells 100 as can fit within the enclosure 10 volume along its elongate axis once the various electronic equipment is secured within. Within the present context, the various pieces of electronic equipment that can be mounted within enclosure 10 includes at least three major packages (also referred to herein either individually or collectively as units), the first of which is the battery disconnect unit (BDU), while the second is called the battery system monitor (BSM) and the third the manual service disconnect (MSD). The BDU is used to disconnect the high voltage source of the module or pack from the vehicle, while the MSD is used as a first line of protection for the servicing technician by halving the pack voltage, and the BSM monitors cell temperature, voltage and current, as well as aids in cell-to-cell balancing.

Referring next to FIG. 4 in conjunction with FIG. 3, support legs 10B may be placed underneath the tray 10A for periodic undergirding; as shown, the support is made possible by the side-to-side (i.e., lateral) extension of the support legs 10B along periodic locations of the tray 10A elongate dimension. Multiple positions of the supports 10B (as well as other components as will become apparent from the discussion below) are possible due to the ability to slide to a desired position along the tray 10A lengthwise direction. The angled profile of support legs 10B are such that they maximize surface contact with the shapes of the corresponding lateral channels of the tray 10A. Assembly between these (as well as other) components is also achieved through other inexpensive fabrication techniques, such as spot welding, laser welding, bonding, riveting, screwing or a combination of one or more of these methods. By maintaining a lengthwise continuous cross-sectional shape, the tray 10A enables use of the same support legs 10B irrespective of where along the tray 10A elongate continuum they are placed (subject to suitably-aligned mounting apertures or the like) while remaining open to the possibility of reworking the panel with a standardized manufacturing approach, if need be. As such, a common component (such as any of the ones discussed herein) may have features added to it without the need to create an entirely new part. For example, a configuration-specific aperture (such as that used to accommodate a fastener that may only be attached in a limited number of locations) may need to be included (such as though the surface of the front or rear panels 10C (discussed below). The same may be subjected to a small offline piercing, trimming or other unit without having to subject it to the rigors of a redesign, remanufacture or the like. Although it is more economical to use identically-shaped support legs 10B in multiple places, the present invention is not so limited, and may therefore accommodate support legs 10B of differing shapes, as long as they support scalability along the elongate dimension of tray 10A. The crosswise connection between the support legs 10B and the tray 10A ensures additional support on the tray 10A lower surface from one lateral edge (for example, the back) of the tray 10A to the opposing lateral edge (for example, the front) to promote lengthwise stiffening and a strong closed lengthwise box section for additional enclosure 10 bending resistance; this is particularly beneficial when the tray 10A is subjected to the weight of numerous stackably aligned batteries 100.

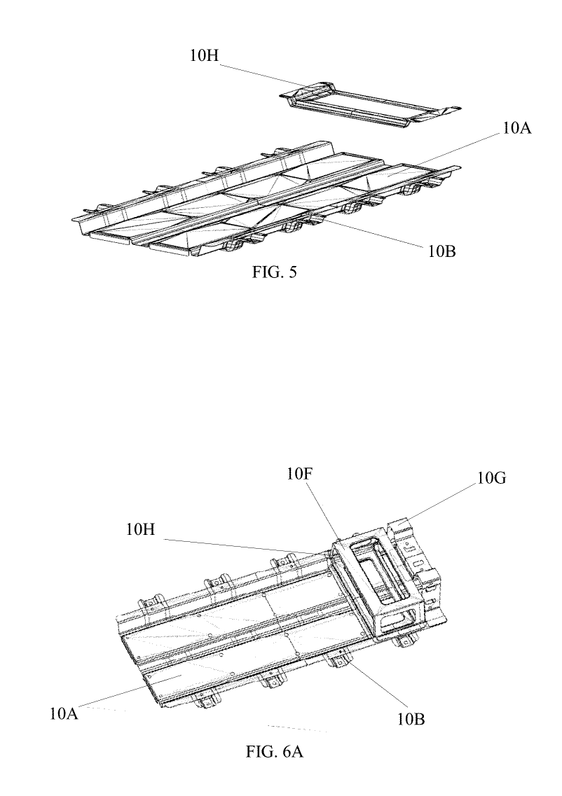

Referring next to FIG. 5 in conjunction with FIG. 3, one of the three brackets that are used to secure the various electronic equipment mentioned above within the enclosure 10 is shown in more detail. In particular, a battery disconnect module (or unit) bracket (or reinforcement) 10H is used for supporting the BDU that selectively couples the various battery cells to the motors (such as motor 15) or other automotive loads. As with the support legs 10B, the battery disconnect module bracket 10H is slidably mountable such that it may be secured to the top of tray 10A anywhere along its length, depending on where the placement of the numerous battery cells 100 (not presently shown) within enclosure 10 is desired. As with the connection between the tray 10A and the supports 10B, the battery disconnect module bracket 10H may be secured to the tray 10A either by welding, bonding riveting, screwing, or a combination of one or more of these methods. These attachments may be along the lengthwise stiffening channels to promote a rigid, closed lengthwise box section that is especially resistant to deformation in the dimension perpendicular to the lengthwise direction of the tray 10A.

Referring next to FIGS. 6A through 6C, use and placement of the other two major electronic equipment brackets are shown. In particular, a battery system monitor bracket 10F and a manual service disconnect bracket 10G are used with the BSM and MSD respectively along any desired location of the elongate axis of the tray 10A is shown. As with the support legs 10B and battery disconnect module bracket 10H mentioned above, the battery system monitor bracket 10F and the manual service disconnect bracket 10G are slidably mountable such that they may be secured to the top of tray 10A anywhere along the tray 10A length; this feature is important to help ensure secure mechanical and electrical attachment of the batteries 100 and their associated cabling to the electrical connectivity, control and monitoring equipment 12 that is discussed in more detail below. The modular nature of the present invention also includes the ability to rotate these two components 180° about the vertical axis such that the manual service disconnect bracket 10G is facing the left end while the battery system monitor bracket 10F is facing the right end. Other lesser amounts of rotation may also be employed, depending on the battery pack 10 configuration. The battery system monitor bracket 10F defines a generally hollow rectangular volume into which the battery disconnect unit (not shown) is placed. Although the battery system monitor bracket 10F is shown residing on top of the battery disconnect module bracket 10H, such is not a requirement, as the placement of one upon the other may be reversed, thereby enhancing the reconfigurable nature of enclosure 10 and the components that define it. The use of the battery system monitor bracket 10F to protect the sensitive electrical connectivity, control and monitoring equipment 12. Along with the battery system monitor bracket 10F and the manual service disconnect bracket 10G, the battery disconnect module bracket 10H may be mounted along the length of tray 10A to a position that allows a specific battery pack length variant to be built.

Significantly, the invariant shape of the joining surfaces between one or all of these three brackets and the companion tray 10A upper surface promotes slidable mounting therebetween, irrespective of where along the constant cross sectional shape of the tray 10A lengthwise direction they are placed; this in turn facilitates enclosure 10 modularity. In one preferred form, the batteries 100 are arranged in modules 200 (as discussed above and shown in FIG. 15) such that the number of at least one of each of these brackets (such as at least the battery disconnect module bracket 10H) may coincide with the number of modules 200 placed upon each tray 10A. As discussed above, in one non-limiting form, each tray 10A may be sized to accommodate between one and eight battery modules 200. That way, should a smaller number of batteries 100 or corresponding modules 200 be needed for a particular battery pack configuration, the companion brackets may be adjusted within enclosure 10 without the need for redesign of the enclosure 10 or its constituent components 10A through 10I, as the slidably-connectable engagement is infinitely adjustable.

The reconfigurable/modular nature of the enclosure 10 of the present invention may be further elucidated with an example. In one form, a single roll tray set of forming rollers (such as those used as a pair of complementary-shaped in rollform dies) could support at least two tray 10A lengths, five support 10B configurations, three MSD placement locations, four BDU placement configurations and two BSM locations for at least seventy two combinations.

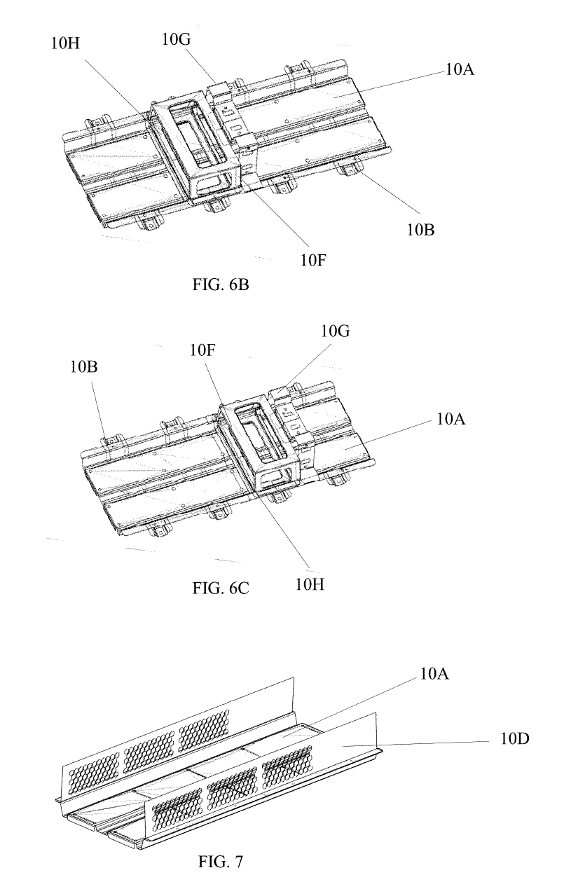

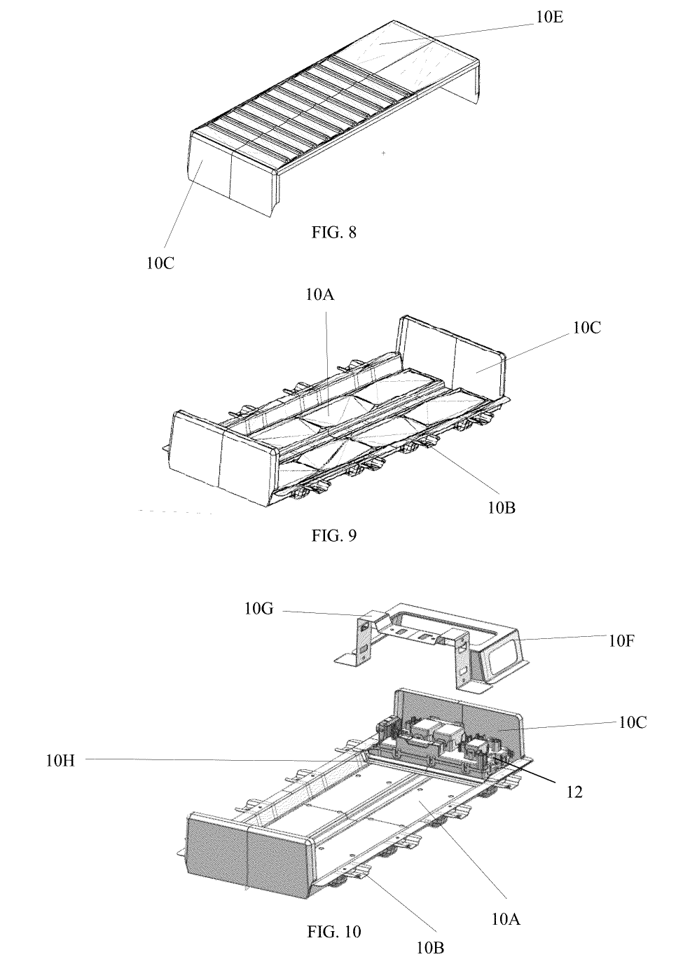

Referring next to FIGS. 7 through 9, front, top and end covering of the tray 10A is provided. the end of the tray 10A includes one or more flanges to promote attachment of closeout panels 10C on opposing ends. As with tray 10A, apertures may be formed through their surfaces to facilitate the use of fasteners (not shown). The closeout panels 10C protect the stacking or aligned battery cells 100 from contaminants, such as dust, water or the like, from entering the enclosure 10 through the ends. The front and rear panels 10D are made from pre-perforated strips of planar material. The top cover 10E is made from a die with replaceable inserts. Thus, one method to reduce fabrication cost of the top cover 10E (which may apply to other components discussed herein as well) is to construct a die to enable the making of several lengths in a single die by using insertable features (such as punches). For example, it may be desirable to form a manual service disconnect aperture on the top for one vehicle variant, while on the back for another. In this way, the same die could be used, but a particular punch may be functional on one panel, and deleted for another.

As with the end panels 10C, they protect the battery cells 100 from contaminants, such as dust, water or the like, as well as from inadvertent contact with the exposed terminals 110, 120 that project out of the cell 100 top edges. A removable cap 10I is situated in an aperture formed in cover 10E to allow ease of access to the high voltage positive or negative cables that are connected to the terminals 110, 120.

Referring next to FIGS. 10 through 12 in conjunction with FIG. 3, the components 10A, 10B, 10C, 10D, 10E, 10F, 10G, 10H and 10I that were shown in FIGS. 3 through 9 are depicted in various stages of formation into an assembled, modular battery enclosure 200 for use in containing a plurality of battery cells 100. FIG. 10 shows with particularity that the battery system monitor bracket 10F and the manual service disconnect bracket 10G may be placed over the region of tray 10A where the electrical connectivity, control and monitoring equipment 12 is placed. Although not shown in detail, such equipment 12 may include battery disconnect features, as well as other connectivity and integration devices. Furthermore, the battery electrical connectivity, control and monitoring equipment 12 is in the form of one or more self-contained battery electronics modules that are compatible with the reconfigurable nature of enclosure 10. As mentioned above, this equipment is used in conjunction with the battery cells 100 (not presently shown for clarity) in order to ensure proper delivery of the electric current generated within the cells 100 to a motor or other load within a vehicle 1.

The battery system monitor bracket 10F and the manual service disconnect bracket 10G are shown as being lowered onto the battery disconnect module bracket 10H that is in turn mounted onto tray 10A; these two components can be used separately, or as an assembly, and may also be reversed (in the manner discussed above in conjunction with FIGS. 6A through 6C), or made as a partial bracket. In addition to being rotatable, the manual service disconnect bracket 10G may assume other shapes (not shown), depending on the need; in one form, it could also be smaller (for example, about half the size along the widthwise dimension).

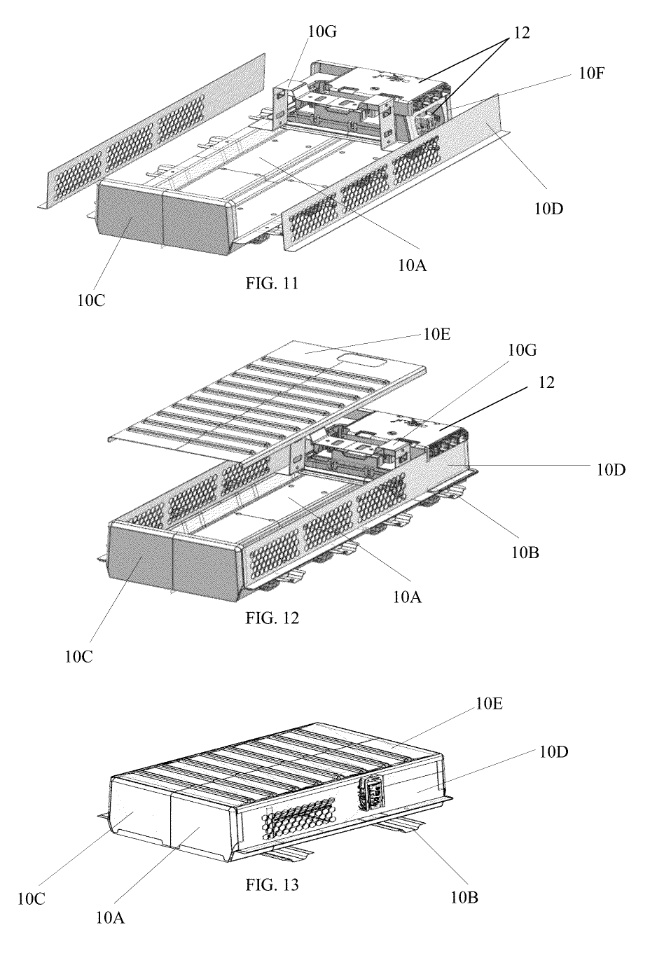

Referring with particularity to FIG. 11 in conjunction with FIG. 3, the general position of the placement of the front and rear panels 10D (which act as a debris screen) is shown. The clusters of apertures that make up a screen are grouped depending on the desired amount of air passage, as well as the number of cells 100 or modules 200 inside the battery pack. The screen pattern may be manufactured using traditional perforation processes. Horizontal flanging as shown can be accomplished by using traditional low force flanging methods, or can be roll formed. In an alternate configuration (not shown), the front and rear panels 10D may be attached to the tray 10A Likewise (also not shown), the front and rear panels 10D can be of different lengths from one another, depending on the desired configuration. Together, closeouts 10C and the front and rear panels 10D stand vertically upright relative to tray 10A to define a substantially rectangular, box-like volume into which the battery cells 100 and the battery electrical connectivity, control and monitoring equipment 12 may be mounted.

An important attribute of the present invention is that many of the components may be assembled in varying orders, and further that some may be grouped together as parts of preassemblies; for example, a preassembly configuration with closeout panels 10C affixed to the tray 10A may take place first, after which the front and back screens 10D are added. Likewise, some of the components may be introduced first as individual (i.e., loose) parts, such as the addition of the top cover 10E that may be first affixed to one or both of the front and back screens 10D, closeout plates 10C or affixed to both prior to assembly. In another variation, the top cover 10E is affixed to the front and back screens 10D before the closeout plates 10C. As mentioned above, assembly of the various components may be accomplished by using welds, adhesives, rivets, screws as appropriate. Much of the assembly sequence may be dictated by access to key battery pack components.

It is noted that terms like “preferably”, “commonly” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention. Likewise, terms such as “substantially” are utilized to represent the inherent degree of uncertainty that may be attributed to any quantitative comparison, value, measurement, or other representation. It is also utilized to represent the degree by which a quantitative representation may vary from a stated reference without resulting in a change in the basic function of the subject matter at issue.

For the purposes of describing and defining the present invention it is noted that the term “device” is utilized herein to represent a combination of components and individual components, regardless of whether the components are combined with other components. For example, a device according to the present invention may comprise a battery or related source of electric power that in turn may be used to provide motive power. A device may also refer to a vehicle incorporating the source of motive power or other equipment that may make up, or be used in conjunction with, the vehicle or source of motive power; the nature of the device will be clear from the context. Furthermore, variations on the terms “automobile”, “automotive”, “vehicular” or the like are meant to be construed generically unless the context dictates otherwise. As such, reference to an automobile will be understood to cover cars, trucks, buses, motorcycles and other similar modes of transportation unless more particularly recited in context Likewise, the invention may be used in conjunction with battery cells unrelated to automotive applications, where temperature-sensitive equipment may need added thermal protection; such additional configurations are understood as being within the scope of the present invention.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

What is claimed is:

1. A modular automotive battery pack assembly comprising:
a tray defining a mounting surface thereon to accept a plurality of prismatic batteries such that an elongate dimension defined by said mounting surface is possessive of a substantially constant cross section therealong; and
a plurality of components cooperative with said tray such that upon at least one of direct or indirect attachment therebetween, a modular enclosure is defined about a substantial entirety of said batteries, said components comprising:
a plurality of upstanding walls disposed about a substantial periphery of said tray;
a plurality of brackets disposed along a portion of said mounting surface such that said brackets substantially fit within a volume defined by said walls and said tray, at least one of said brackets in cooperation with said tray such that attachment therebetween is invariant regardless of where along said elongate dimension said cooperation occurs; and
a top cover disposed over said volume.

2. The assembly of claim 1, wherein said tray mounting surface defines a substantially planar profile along at least a majority of its length.

3. The assembly of claim 1, further comprising at least one support disposed against a lower surface of said tray.

4. The assembly of claim 3, wherein said at least one support comprises a plurality of supports spaced along said elongate dimension, each of said plurality of supports extending from one lateral edge of said tray to a substantially opposing lateral edge.

5. The assembly of claim 1, wherein at least one of said components defines a slidably mountable cooperation with said tray.

6. The assembly of claim 1, wherein at least one of said walls defines a plurality of apertures therein.

7. The assembly of claim 1, wherein said brackets comprise electrical equipment containment within said enclosure.

8. The assembly of claim 7, wherein said brackets are selected from the group consisting of a battery disconnect module bracket, a battery system monitor bracket and a manual service disconnect bracket.

9. The assembly of claim 8, wherein at least one of said manual service disconnect bracket and said battery system monitor bracket is configured such that it is rotatably mountable to said tray in more than one orientation.

10. The assembly of claim 1, wherein a stacking axis of at least a portion of said batteries is substantially parallel to an elongate dimension of said tray.

11. The assembly of claim 1, wherein a stacking axis of at least a portion of said batteries is substantially parallel to a widthwise dimension of said tray.

12. The assembly of claim 1, wherein a stacking axis of at least a portion of said batteries is substantially parallel to an elongate dimension of said tray while a stacking axis of at least another portion of said batteries is substantially parallel to a widthwise dimension of said tray.

13. An automotive battery pack assembly comprising:
a plurality of prismatic batteries aligned along a stacking axis;
a plurality of modular components comprising:
a tray defining a mounting surface thereon to accept said batteries, said mounting surface defining an elongate dimension and a widthwise dimension, said mounting surface defining a substantially a constant cross section along said elongate dimension; and
a plurality of components cooperative with said tray such that upon at least one of direct or indirect attachment therebetween, a modular enclosure is defined about a substantial entirety of said batteries, said components comprising a plurality of upstanding walls disposed about a substantial periphery of said tray, a top cover disposed over said walls, and a plurality of brackets disposed along a portion of said mounting surface such that said brackets are in cooperation with said tray such that attachment therebetween is invariant regardless of where along said elongate dimension said cooperation occurs.

14. The assembly of claim 13, wherein said batteries are arranged in modules such that a number of at least of said brackets is the same as a corresponding number of said modules.

15. The assembly of claim 13, wherein said brackets are slidably movable along said elongate dimension of said mounting surface.

16. The assembly of claim 13, wherein a stacking axis of at least a portion of said batteries is substantially parallel to an elongate dimension of said tray while a stacking axis of at least another portion of said batteries is substantially parallel to a widthwise dimension of said tray.

17. The assembly of claim 13, further comprising a plurality of electrical equipment units contained within said enclosure, each of said units secured to a corresponding one of said brackets.

18. A method of assembling an automotive battery pack, said method comprising:
placing a plurality of prismatic batteries on a support surface such that said batteries are aligned along a stacking axis, said mounting surface defining a substantially constant cross section along said elongate dimension; and
placing a plurality of components cooperative with said support surface such that upon at least one of direct or indirect attachment therebetween, a modular enclosure is defined about a substantial entirety of said batteries, at least one of said components comprising a plurality of brackets disposed along a portion of said mounting surface such that said brackets are in cooperation with said tray such that attachment therebetween is invariant regardless of where along said elongate dimension said cooperation occurs.

19. The method of claim 18, wherein at least one of said brackets is slidably disposed onto said support surface prior to fixed attachment therebetween.

20. The method of claim 18, wherein said attachment between said support surface and at least one of said components is selected from the group consisting of spot welding, laser welding, bonding, riveting, screwing or a combination thereof.

21. The method of claim 18, wherein all of said components are manufactured prior to said assembly by roll forming, perforation, low force flanging of a combination thereof.
